(19) United States
(12) Patent Application Publication
(10) Pub. No.: US 2015/0015423 A1
(43) Pub. Date: Jan. 15, 2015

(54) VEHICLE KEY

(71) Applicant: KABUSHIKI KAISHA TOKAI RIKA DENKI SEISAKUSHO, Aichi (JP)

(72) Inventor: Shuichi TAKEUCHI, Aichi (JP)

(21) Appl. No.: 14/312,893

(22) Filed: Jun. 24, 2014

(30) Foreign Application Priority Data
Jul. 10, 2013 (JP) 2013-144776

(51) Int. Cl. G08G 1/123

(52) U.S. Cl. CPC G08G 1/123
USPC 340/989

(57) ABSTRACT

A vehicle key includes a light emitting body and a controller that locates a vehicle corresponding to the vehicle key. The controller indicates the location of the vehicle by controlling illumination of the light emitting body in a first illumination mode, which corresponds to a distance from the vehicle key to the vehicle, and a second illumination mode, which indicates whether or not the vehicle key is oriented in a direction that conforms to a direction to the vehicle.

### CROSS-REFERENCE TO RELATED APPLICATIONS

This application is based upon and claims the benefit of priority from prior Japanese Patent Application No. 2013-144776, filed on Jul. 10, 2013, the entire contents of which are incorporated herein by reference.

### FIELD

The present invention relates to a vehicle key including a vehicle location function for locating a vehicle.

### BACKGROUND

Japanese Laid-Out Patent Publication No. 2006-125983 describes a technique for locating a vehicle by showing the bearings of the vehicle on a display of a vehicle key. This technique is convenient since it allows the user to locate the vehicle with the information shown on the key display. For example, the technique would be convenient when used in a very large parking lot.

The use of, for example, a liquid crystal display (LCD) is preferred since the bearings of the vehicle may be shown in detail on the display. However, an LCD would enlarge the vehicle key and increase the weight of the key. This would raise costs. Further, when the vehicle key is driven by a battery, the LCD would increase power consumption and drain the battery.

### SUMMARY

One aspect of the present invention includes a vehicle key including a light emitting body and a controller. The controller indicates a location of a vehicle corresponding to the vehicle key by controlling illumination of the light emitting body in a first illumination mode, which corresponds to a distance from the vehicle key to the vehicle, and a second illumination mode, which indicates whether or not the vehicle key is oriented in a direction that conforms to a direction to the vehicle.

A further aspect of the present invention is a vehicle key including a vehicle key, a light emitting body, and a controller. The controller indicates a location of a vehicle corresponding to the vehicle key by controlling illumination of the light emitting body in an illumination mode that indicates whether or not a direction in which the vehicle key is oriented conforms to a direction to the vehicle.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram illustrating the configuration of an electronic key system;

FIG. 2 is a front view of a vehicle key; and

FIG. 3 is a schematic diagram illustrating an operation for locating a vehicle.

### DESCRIPTION OF THE EMBODIMENTS

One embodiment of a vehicle key will now be described.

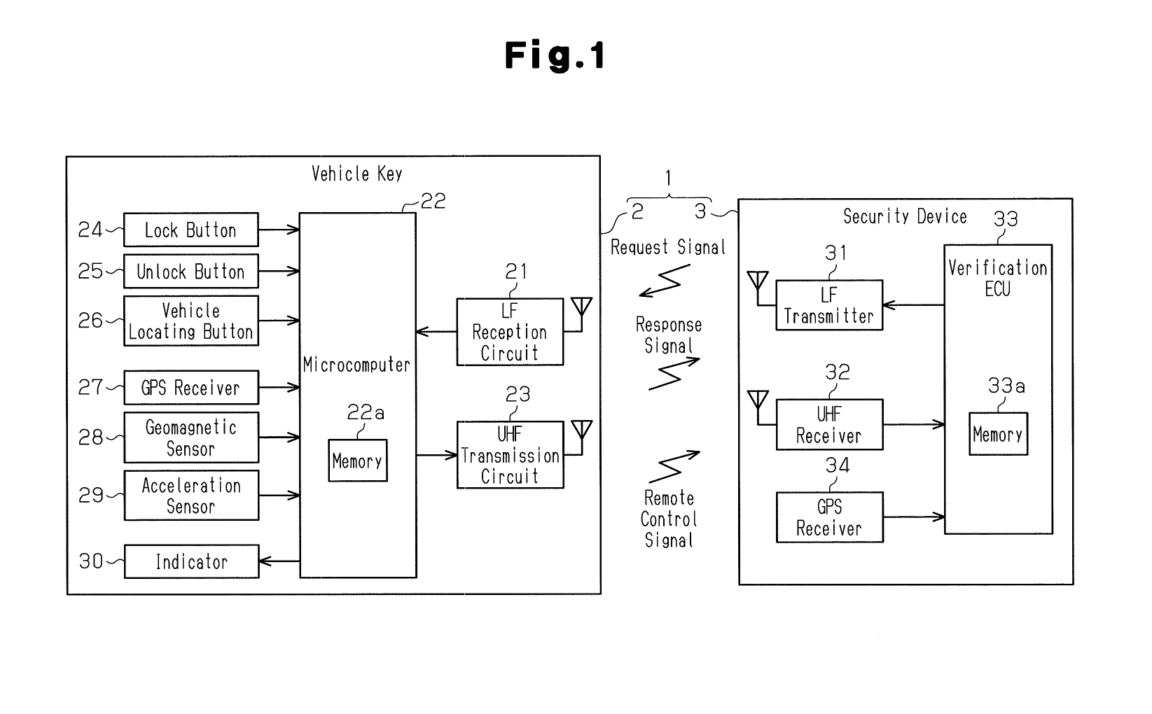

With reference to FIG. 1, an electronic key system 1 includes a vehicle key 2, which functions as an electronic key, and a security device 3, which is installed in a vehicle. The vehicle key 2 may perform bidirectional communication with the security device 3 using radio waves. The vehicle key 2 may also be used as a transmitter that performs unidirectional communication. Bidirectional communication uses radio waves on the LF band and the UHF band, and unidirectional communication uses radio waves on the UHF band. The vehicle key 2 may also be referred to as a portable device. The electronic key may be a remote control key or a Smart Key (registered trademark).

The vehicle key 2 includes an LF reception circuit 21, a microcomputer 22 serving as a controller, a UHF transmission circuit 23, a lock button 24, an unlock button 25, a vehicle locating button 26, a Global Positioning System (GPS) receiver 27, a geomagnetic sensor 28, an acceleration sensor 29, and an indicator 30. Each of the lock button 24, the unlock button 25, and the vehicle locating button 26 is one example of an operated portion.

The security device 3 transmits a request signal on an LF radio wave to a predetermined transmission area around the vehicle. The LF reception circuit 21 receives the request signal. The request signal is used to request the vehicle key 2 to transmit identification information (ID) that is used by the security device 3 to verify the vehicle key 2. When the vehicle key 2 is located in the transmission area, the LF reception circuit 21 is capable of receiving the request signal. The LF reception circuit 21 electrically processes, for example, demodulates, the request signal to generate a reception signal. Then, the LF reception circuit 21 sends the reception signal to the microcomputer 22.

The microcomputer 22 includes a non-volatile memory 22a. The memory 22a stores an ID unique to the vehicle key 2. In response to the request signal received by the LF reception circuit 21, the microcomputer 22 sends a primary signal, which includes the ID of the vehicle key 2, to the UHF transmission circuit 23.

The UHF transmission circuit 23 electrically processes, for example, modulates, the primary signal from the microcomputer 22 to generate a response signal for the request signal. Then, the UHF transmission circuit 23 transmits the response signal on a UHF radio wave to an area around the vehicle key 2.

The lock button 24, which is a push button type switch, sends a detection signal to the microcomputer 22 when pushed. The pushing of the lock button 24 may be referred to as an input operation. In response to the detection signal from the lock button 24, the microcomputer 22 sends a primary signal, which includes a door lock request code and the ID of the vehicle key 2, to the UHF transmission circuit 23. In response to the door lock request code, the UHF transmission circuit 23 transmits a remote control signal on a UHF radio wave to request for the vehicle doors to be locked.

The unlock button 25, which is a push button type switch, sends a detection signal to the microcomputer 22 when pushed. The pushing of the unlock button 25 may be referred to as an input operation. In response to the detection signal from the unlock button 25, the microcomputer 22 sends a primary signal, which includes a door unlock request code and the ID of the vehicle key 2, to the UHF transmission circuit 23. In response to the door unlock request code, the UHF transmission circuit 23 transmits a remote control signal on a UHF radio wave to request for the vehicle doors to be unlocked.

The vehicle locating button 26 is a push button type switch used by the user to perform an operation that triggers a process for locating the vehicle that corresponds to the vehicle key 2. The vehicle locating button 26 sends a detection signal to the microcomputer 22 when pushed. The pushing of the vehicle locating button 26 may be referred to as an input operation. In response to the detection signal from the vehicle locating button 26, the microcomputer 22 performs a vehicle locating process. The vehicle locating process includes a process for locating the vehicle and a process for indicating to the user where the vehicle is located. The process for locating the vehicle includes a process for calculating the distance from the vehicle key 2 to the vehicle and a process for calculating the direction from the vehicle key 2 to the vehicle. The process for indicating the vehicle location includes a process for determining whether or not the direction in which the vehicle key 2 is oriented conforms to the direction to the vehicle. In the vehicle key 2 of the present embodiment, the microcomputer 22 functions as a distance calculation unit, a direction calculation unit, and a direction determination unit.

The GPS receiver 27 is capable of receiving GPS signals from GPS satellites. When receiving a GPS signal, the GPS receiver 27 sends the received GPS signal to the microcomputer 22. The microcomputer 22 analyzes the received GPS signal to obtain positional information of the vehicle key 2. The positional information of the vehicle key 2 includes coordinates indicating latitude and longitude. In the vehicle key 2 of the present embodiment, the GPS receiver 27 functions as a key position acquisition unit.

The geomagnetic sensor 28 detects the bearings of the vehicle key 2 (direction in which vehicle key 2 is oriented) and sends a bearing detection signal to the microcomputer 22. The acceleration sensor 29 detects the acceleration applied to the vehicle key 2 and sends an acceleration detection signal to the microcomputer 22. In the vehicle key 2 of the present embodiment, the geomagnetic sensor 28 and the acceleration sensor 29 form an orientation detector that functions to detect the orientation of the vehicle key 2.

The indicator 30 functions as a light emitting body in the present embodiment. The indicator 30 includes a light emitting diode (LED) that emits light of a single color, for example, red. The microcomputer 22 executes illumination control so that the indicator 30 is intermittently illuminated, continuously illuminated, or switched off.

The security device 3 includes an LF transmitter 31, a UHF receiver 32, a verification electronic control unit (ECU) 33, and a GPS receiver 34.

The LF transmitter 31 electrically processes, for example, modulates, a primary signal provided from the verification ECU 33 to generate a request signal. Then, the

LF transmitter 31 transmits the request signal to the area around the vehicle. The LF transmitter 31 includes an internal transmitter which transmits a request signal to an area inside the vehicle, and external transmitters each of which transmits a request signal to an area outside the vehicle. Each vehicle door may include an external transmitter. The area to which a request signal is transmitted from the external transmitter in, for example, the driver door is set in a range of 0.7 meter to 1.0 meter from the driver door.

The UHF receiver 32 is capable of receiving response signals and remote control signals from the vehicle key 2. The UHF receiver 32 electrically processes, for example, demodulates, a response signal or a remote control signal to generate a reception signal. Then, the UHF receiver 32 sends the reception signal to the verification ECU 33.

The verification ECU 33 includes a non-volatile memory 33a. The ID of the authentic vehicle key 2 corresponding to the vehicle is registered as a reference ID to the memory 33a. The verification ECU 33 obtains the ID of the vehicle key 2 from the reception signal (response signal or remote control signal) received by the UHF receiver 32 and verifies the ID with the reference ID. Under the condition that ID verification has been accomplished, the verification ECU 33 permits vehicle operations.

For example, when the vehicle is parked and the vehicle doors are locked, the verification ECU 33 periodically transmits a request signal from the LF transmitter 31 to areas outside the vehicle. When the vehicle key 2 enters an area to which the request signal is transmitted, the vehicle key 2 transmits a response signal, and the verification ECU 33 analyzes the response signal. Under the condition that ID verification has been accomplished, unlocking of the vehicle doors is permitted.

When, for example, the driver door is opened and then closed, the verification ECU 33 transmits a request signal from the LF transmitter 31 to inside of the vehicle. When the vehicle key 2 enters the area to which the request signal is transmitted, the vehicle key 2 transmits a response signal, and the verification ECU 33 analyzes the response signal. Under the condition that ID verification has been accomplished, starting of the engine is permitted.

When, for example, a door lock switch on an outer handle of the driver door is operated, the verification ECU 33 transmits a request signal from the LF transmitter 31 to the outside of the vehicle. When the vehicle key 2 enters the area to which the request signal is transmitted, the vehicle key 2 transmits a response signal, and the verification ECU 33 analyzes the response signal. Under the condition that ID verification has been accomplished, the vehicle doors are locked.

The GPS receiver 34 is capable of receiving GPS signals from GPS satellites. When receiving a GPS signal, the GPS receiver 34 sends the received GPS signal to the verification ECU 33. The verification ECU 33 analyzes the received GPS signal to obtain positional information of the vehicle. The positional information of the vehicle includes coordinates indicating latitude and longitude. In the present embodiment, for example, in response to the door lock switch (or lock button 24 of vehicle key 2) being operated, the verification ECU 33 transmits a request signal that includes the positional information of the vehicle. Thus, the vehicle key 2 obtains the positional information of the vehicle. In the vehicle key 2 of the present embodiment, the LF reception circuit 21 functions as a vehicle position acquisition unit.

The operation of the vehicle key 2 will now be described.

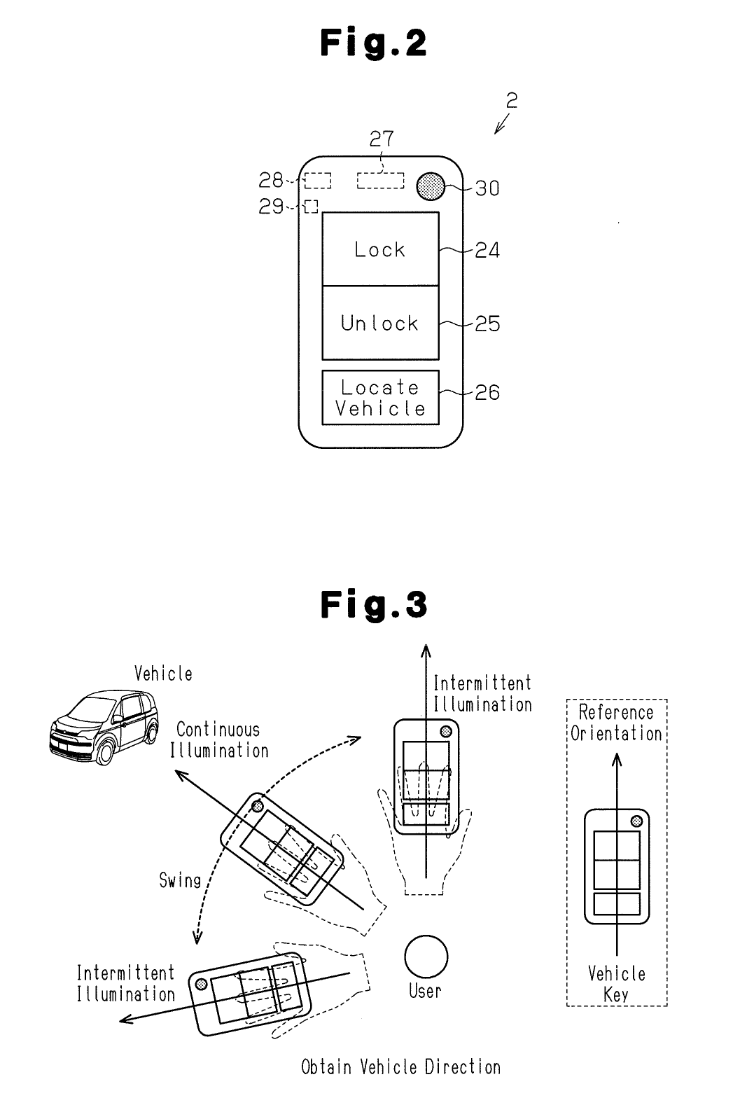

Referring to FIG. 2, the vehicle key 2 includes an ornamental surface on which the lock button 24, the unlock button 25, and the vehicle locating button 26 are arranged in a row. The orientation of the vehicle key 2 when the user holds the vehicle key 2 so that the vehicle locating button 26 is located closer to the user than the lock button 24 is set as a reference orientation of the vehicle key 2. The indicator 30 is proximal to the lock button 24 and located on the same side of the vehicle key 2 as the buttons 24 to 26. The GPS receiver 27, the geomagnetic sensor 28, and the acceleration sensor 29 are accommodated in the case of the vehicle key 2.

When a user parks a vehicle in a large parking lot where many other vehicles are parked, the user may not be able to find his or her vehicle. For such a case, the vehicle key 2 is provided with a vehicle locating function that aids the user so that the user can easily locate his or her vehicle. In the present embodiment, when the user operates the door lock switch (or lock button 24 of vehicle key 2) after parking his or her vehicle, the vehicle key 2 obtains the positional information of the vehicle.

When the user cannot find his or her vehicle in a parking lot, the user operates the vehicle locating button 26 while holding the vehicle key 2 in conformance with the reference orientation. As a result, the microcomputer 22 obtains the positional information of the vehicle key 2 to calculate the distance between the vehicle key 2 and the vehicle from the positional information of the vehicle corresponding to the vehicle key 2 and the positional information of the vehicle key 2. Then, the microcomputer 22 intermittently illuminates the indicator 30 in accordance with the distance from the vehicle key 2 to the vehicle. For example, the microcomputer 22 intermittently illuminates the indicator 30 in shorter intervals as the distance to the vehicle decreases. This allows the user to recognize the distance to the vehicle based on the intermittent illumination interval of the indicator 30.

Referring to FIG. 3, when the indicator 30 is intermittently illuminated, the user horizontally moves, or swings, the vehicle key 2 while holding the vehicle key 2 in conformance with the reference orientation. When the direction in which the vehicle key 2 is oriented conforms to the direction of the vehicle, the microcomputer 22 starts to continuously illuminate the indicator 30, which had been intermittently illuminated. Continuous illumination of the indicator 30 indicates the direction to the vehicle that may be inferred from the direction in which the vehicle key 2 is oriented. The microcomputer 22 calculates the direction to the vehicle from the positional information of the vehicle and the positional information of the vehicle key 2. When the vehicle key 2 is moved, or swung, by the user, the microcomputer 22 obtains the orientation of the vehicle key 2 from the bearing detection signal of the geomagnetic sensor 28 and the acceleration detection signal of the acceleration sensor 29. Then, the microcomputer 22 specifies the direction in which the vehicle key 2 is oriented from the orientation of the vehicle key 2, and determines whether the vehicle key 2 is oriented in the direction to the vehicle. When the direction in which the vehicle key 2 is oriented conforms to the direction to the vehicle, the microcomputer 22 continuously illuminates the indicator 30. When the direction in which the vehicle key 2 is oriented does not conform to the direction to the vehicle, the microcomputer 22 keeps intermittently illuminating the indicator 30. In the present embodiment, the intermittent illumination of the indicator 30 is one example of a first illumination mode, and the continuous illumination of the indicator 30 is one example of a second illumination mode.

The present embodiment has the advantages described below.

(1) The user may infer the distance to the vehicle from the intermittent illuminating interval of the indicator 30. Further, the user may infer the direction of the vehicle from the orientation of the vehicle key 2 when the indicator 30 is continuously illuminated. This allows the vehicle key 2 to indicate the vehicle location to the user with the indicator 30, such as an LED, and eliminates the need for an LCD. Accordingly, the vehicle key 2 allows for the indication of the vehicle location while having a simple and compact structure.

(2) The indicator 30 is not constantly illuminated. The indicator 30 is illuminated only when the vehicle locating button 26 is operated. This decreases battery drainage in the vehicle key 2.

(3) The vehicle key 2 cooperates with the security device 3 and easily obtains the distance to the vehicle.

(4) The vehicle key 2 cooperates with the security device 3 and easily obtains the direction to the vehicle.

(5) The user may easily locate the vehicle just by operating the vehicle locating button 26, which functions as a dedicated switch.

(6) The user may locate the vehicle by horizontally moving, or swinging, the vehicle key 2.

It should be apparent to those skilled in the art that the present invention may be embodied in many other specific forms without departing from the spirit or scope of the invention. Particularly, it should be understood that the present invention may be embodied in the following forms.

In the above embodiment, when locking the vehicle doors, the request signal including the positional information of the vehicle is transmitted. Instead, the security device 3 may transmit the positional information of the vehicle in response to a request from the vehicle key 2 when, for example, the vehicle locating button 26 or another button is operated under a situation in which communication is established between the vehicle key 2 and the security device 3. In this manner, the timing in which the vehicle key 2 receives the positional information of the vehicle is not limited to when the vehicle doors are locked. Further, the vehicle key 2 does not have to receive the positional information of the vehicle at the same time as the request signal.

The indicator 30 is not limited to an LED that emits light of a single color. An LED that emits light of multiple colors may be used as the indicator 30. In this case, the indicator 30 may be intermittently illuminated with a color associated with the distance to the vehicle. When the direction in which the vehicle key 2 is oriented conforms to the direction of the vehicle, the indicator 30 is continuously illuminated with the light of the present color. In this structure, the user may simultaneously recognize the distance to the vehicle and the direction of the vehicle when the indicator 30 illuminated with the color associated with the distance to the vehicle changes from an intermittently illuminated state to a continuously illuminated state.

The illumination mode of the indicator 30 does not have to be changed in accordance with the distance from the vehicle key 2 to the vehicle. For example, the indicator 30 may be intermittently illuminated in fixed intervals. In this case, when the direction in which the vehicle key 2 is oriented does not conform to the direction of the vehicle, the indicator 30 is intermittently illuminated in the fixed intervals. When the two directions are in conformance, the indicator 30 is continuously illuminated. Alternatively, when the direction in which the vehicle key 2 is oriented does not conform to the direction of the vehicle, the indicator 30 may be switched off. In this case, when the two directions are in conformance, the indicator 30 is continuously illuminated. Further, if the indicator 30 includes a multicolor LED, the indicator 30 may be continuously or intermittently illuminated with the light of a first color (e.g., red) when the two directions are not in conformance and may be continuously illuminated with the light of a second color (e.g., blue) when the two directions are in conformance.

The vehicle key 2 may include two indicators 30. In this case, one indicator 30 is used to indicate the distance to the vehicle, and the other indicator 30 is used to indicate the direction to the vehicle. Such a structure also simplifies the vehicle key 2 as compared with when using an LCD.

The indicator 30 may be configured to emit light for only a certain period from when the vehicle locating button 26 is operated. This differs from a configuration in which the indicator 30 continues to emit light after the vehicle locating button 26 is operated in that the period during which the indicator emits light is limited. This decreases battery drainage in the vehicle key 2.

The indicator 30 may be configured to emit light only when the vehicle locating button 26 is being operated. This configuration allows the user to recognize that the vehicle locating button 26 is being operated to locate the vehicle. This decreases battery drainage in the vehicle key 2.

Instead of the dedicated vehicle locating button 26, one or more existing functional buttons, such as the lock button 24 and/or the unlock button 25, may be used to locate a vehicle. In this case, the microcomputer 22 recognizes a specific operation performed on an existing functional switch as an operation that triggers the process for locating the vehicle. This allows for the dedicated vehicle locating button 26 to be omitted and limits enlargement of the vehicle key 2. The specific operation differs from normal operations and may be, for example, a certain number of operations performed during a predetermined period, a continuously operated time, or simultaneous operation of a plurality of existing switches.

The present examples and embodiments are to be considered as illustrative and not restrictive, and the invention is not to be limited to the details given herein, but may be modified within the scope and equivalence of the appended claims.

1. A vehicle key comprising:
a light emitting body; and
a controller that indicates a location of a vehicle corresponding to the vehicle key by controlling illumination of the light emitting body in a first illumination mode, which corresponds to a distance from the vehicle key to the vehicle, and a second illumination mode, which indicates whether or not the vehicle key is oriented in a direction that conforms to a direction to the vehicle.

2. The vehicle key according to claim 1, further comprising an operated portion operated to trigger a process for locating the vehicle.

3. The vehicle key according to claim 1, further comprising:
a vehicle position acquisition unit that acquires positional information of the vehicle corresponding to the vehicle key through communication with the vehicle;
a key position acquisition unit that acquires positional information of the vehicle key; and
a distance calculation unit that calculates the distance from the vehicle key to the vehicle from the positional information of both of the vehicle and the vehicle key.

4. The vehicle key according to claim 1, further comprising:
a vehicle position acquisition unit that acquires positional information of the vehicle corresponding to the vehicle key through communication with the vehicle;
a key position acquisition unit that acquires positional information of the vehicle key;
a direction calculation unit that calculates the direction to the vehicle from the positional information of both of the vehicle and the vehicle key;
an orientation detector that detects an orientation of the vehicle key; and
a direction determination unit that determines from the orientation of the vehicle key whether or not the vehicle key is oriented in a direction that conforms to the direction to the vehicle.

5. The vehicle key according to claim 1, wherein
the first illumination mode includes intermittently illuminating the light emitting body in intervals associated with the distance from the vehicle key to the vehicle, and
the second illumination mode includes continuously illuminating the light emitting body when the vehicle key is oriented in a direction that conforms to the direction to the vehicle.

6. The vehicle key according to claim 1, wherein
the first illumination mode includes intermittently illuminating the light emitting body with light of a color associated with the distance from the vehicle key to the vehicle, and
the second illumination mode includes continuously illuminating the light emitting body when the vehicle key is oriented in a direction that conforms to the direction to the vehicle.

7. The vehicle key according to claim 2, wherein the controller is configured to illuminate the light emitting body only for a certain period from when the operated portion is operated.

8. The vehicle key according to claim 2, wherein the controller is configured to illuminate the light emitting body over a period during which the operated portion is being operated.

9. The vehicle key according to claim 2, wherein the operated portion is a dedicated switch used to locate the vehicle.

10. The vehicle key according to claim 2, wherein
the operated portion is implemented by one or more existing functional switches existing on the vehicle key, and
the controller is configured to recognize a specific operation performed with the one or more existing functional switches as an operation that triggers a process for locating the vehicle.

11. The vehicle key according to claim 4, wherein the orientation detector includes
a geomagnetic sensor that detects bearings of the vehicle key, and
an acceleration sensor that detects acceleration applied to the vehicle key.

12. A vehicle key comprising:
a light emitting body; and
a controller that indicates a location of a vehicle corresponding to the vehicle key by controlling illumination of the light emitting body in an illumination mode that indicates whether or not a direction in which the vehicle key is oriented conforms to a direction to the vehicle.
